(19) United States
(12) Patent Application Publication
(10) Pub. No.: US 2012/0047041 A1
(43) Pub. Date: Feb. 23, 2012

(54) Prepaid Network Time Purchasing System

(76) Inventor: Abdul Akel, Columbus, OH (US)

(21) Appl. No.: 13/073,606

(22) Filed: Mar. 28, 2011

Related U.S. Application Data
(60) Provisional application No. 61/317,784, filed on Mar. 26, 2010.

(51) Int. Cl. G06Q 40/00; G06K 19/067

(52) U.S. Cl. 705/24; 235/492; 705/41

(57) ABSTRACT

A prepaid payment card used to reload or credit a prepay account with prepaid service value carrying a unique identifier generated by a payment provider, the unique identifier being associated with prepaid transaction data capable of indicating designated service values and identified service providers, said card enabling purchasers to gift a prepaid payment card having any desired value and without requiring knowledge of the end user's service provider. Also disclosed are methods for using the prepaid payment card by funding the card at the point of sale or designating a prepaid service value at the moment the unique identifier is generated, so as to provide the benefits of the new prepaid payment card and to mimic the prior art products using the new method. The prepaid payment card may be used to reload a prepay account by providing a reloading interface through which an end user may provide prepay account access information, and then using the access data to transfer consideration from the payment provider to the service provide in exchange for a credit to the prepay account balance.

### CROSS-REFERENCE TO RELATED APPLICATIONS

This application claims the benefit of provisional application 61/317,784, filed on Mar. 26, 2010, the disclosures of which are expressly incorporated herein by reference.

### STATEMENT REGARDING FEDERALLY SPONSORED RESEARCH

None

### BACKGROUND

Cellular telephones first became available to consumers through payment systems that operated on a subscription, or “post pay” basis. Under such a system, a consumer wishing to obtain cellular telephone service would normally contract with a cellular telephone service provider to receive cellular telephone services. These services would be received by the consumer, who would then make a payment for services received during the previous billing period. Because the cellular networks operated in this manner, credit checks were usually required, making it difficult—if not impossible—for a very large portion of consumers with poor credit ratings to obtain cellular service.

Prepaid devices appeared next in the marketplace, aimed at providing cellular service to consumers with poor credit, the unbanked, or to those that desired anonymity with regards to cellular service. The prepaid system for providing cellular service currently involves the initial purchase of a cellular telephone by a consumer wishing to obtain service. The phone is typically associated with a cellular service provider, and is packaged with a plastic card. The plastic card contains a service provider-issued unique identifier. To activate service, a consumer simply calls the service provider and conveys the unique identifier and serial number associated with the phone. The service provider then activates the phone for use on the cellular network and credits the account associated with the phone with an amount associated with the unique identifier. The unique identifier could be associated with a predetermined amount of service minutes, or with an amount of money, which is converted to service minutes at the prevailing exchange rate at the time of activation.

After the account is initially credited, the account balance is incrementally depleted during use of the cellular network. Therefore, a need existed for a method that would allow prepay consumers to prepay for more cellular network time (often called “reloading”) and consequentially increase the credit balance of the account associated with the prepaid phone. Some service providers will allow prepayment through a credit card payment or direct bank transfer. However, these options are often not offered by service providers due to fraud concerns, or are not practical because of many of the reasons for which there was a need for prepaid cellular service in the first place, i.e. poor credit and unbanked consumers. Thus, service providers created prepaid phone cards as a solution to the need for reloading prepaid phones. A service provider begins by generating a set of unique identifiers. These identifiers are associated with a specific dollar amount, e.g. $20, $50, or $75. The identifiers are then printed on a physical plastic card identifying the service provider and covered with scratch-off material to hide the identifier from view. The cards are then sold at a discounted price to distributors and retailers for purchase by consumers.

Retailers have been forced to purchase many different cards in an attempt to provide the largest selection of products to their customers. Using this method, a retailer must buy cards in many different increments and from many different service providers, resulting in a large inventory of cards. The retailer's customers then select an incremental amount for their service provider and purchase the card from the retailer. After purchasing a prepaid card, the end user of the card calls a toll free telephone number that is typically printed on the card or its packaging, scratches off the material to reveal the unique identifier, and conveys the unique identifier to the service provider. The end user also communicates the phone number of their prepay phone to the service provider. The service provider then determines the incremental amount of money associated with the unique identifier, converts that amount to service minutes at the prevailing exchange rate, and credits the account associated with the prepay phone with the corresponding value of service minutes.

The system of prepaid, physical cards thus allowed the service providers to provide cellular service to the large group of consumers that were previously unable to purchase such service. However, the distribution and retail system required retailers to acquire large inventories of prepaid cards—inventories that required shelf space and capital to exist.

In time, service providers began to sell unique identifiers and associated prepaid transaction data to payment providers in electronic transactions—without printing the unique identifiers on a physical card. The unique identifiers and associated prepaid transaction data were electronically generated and transferred to payment providers in exchange for payment. Payment providers installed point of sale activation (POSA) machines in retail locations, which were electronically connected to the payment provider's database of unique identifiers purchased from service providers. A consumer who wished to purchase prepaid network time from a POSA machine simply chose a service provider and desired prepay service value, and paid the requisite price. The POSA machine would then communicate with the payment provider's database, select a unique identifier matching the consumer's request, and print the identifier on a paper receipt. The end user of the prepaid network time then contacted the service provider in the same manner as with the physical prepaid cards.

The main advantage of the POSA system was that it eliminated the need for a retailer to stock a large amount of cards, which freed up valuable shelf space. A retailer could thus stock a virtually unlimited inventory of prepaid cards. Another advantage to the retailer is that the retailer does not pay for this available inventory until a customer makes a purchase, as retailers receive a percentage of the purchase price at this time. Conversely, this is a disadvantage to payment providers, as they are now required to obtain and manage vast inventories of service provider-issued unique identifiers that are not sold to retailers until the consumer makes a purchase. The more disposable type of paper on which the unique identifier is printed can also make it more difficult or less desirable to gift prepaid cards to others.

The service provider-issued unique identifier system was generally also disadvantageous to service providers in the industry. Unique identifiers generated and sold by the service providers at a discount became effective liabilities for the service providers; the service providers had been paid to impart a service that they had not yet provided. This disadvantage led the service providers to implement a real time replenishment (RTR) system. The RTR system eliminated the need for service providers to issue unique identifiers. From the consumer's point of view, they continued to be able to select a service provider and monetary amount. However, the selected monetary amount could now be any amount within a range established by a service provider's particular protocol, e.g. $28.35. Once the service provider was chosen, and the amount was chosen and paid, the payment provider conducting the transaction through a POSA machine electronically interfaced with the service provider's records and exchanged the amount of money paid (less transaction and distribution fees) for minutes at the current market rate for the particular provider. The consumer for whom the transaction was initiated had their account credited for the desired amount, minus fees, and a receipt was printed confirming the transaction. Often the consumer's new minute balance would be noted on the receipt as well, retrieved from the service provider's account records.

While the current state of the art has eliminated the need for large retail inventories, as well as the existence of large liabilities for service providers, it has done so while simultaneously limiting the use of physical phone cards. Physical prepaid cards are a tangible representation of a purchase, something that is desirable to many consumers. Their physical nature is also very useful for gift giving. However, issuing physical cards currently requires large retail inventories in order to be useful, due to the fact that each card is unique to a service provider and monetary increment. Therefore, many permutations must exist in a retailer's inventory so that the retailer can provide an adequate selection to the consumer. This fact presents not only disadvantages for the retailer, but for consumers as well. In order to buy a card to gift or use, a consumer must know the end user's service provider. Purchasing the wrong type of prepaid card can result in a useless purchase.

There exists an acute need for a system and method that would allow for the production of a prepaid payment card that is generic in nature, i.e. one that is service provider or value non-specific. Of particular need is a system that utilizes the benefits of the RTR system, while maintaining all of the benefits of the physical prepaid payment card system. If a system for producing such a generic prepaid payment card were available, consumer, retailer, payment provider and service provider satisfaction would be increased.

### SUMMARY

The present disclosure is directed to a prepaid payment card and related methods that satisfy the need for a system for reloading a prepay account with prepaid service value, that is generic in nature, i.e. capable of being both service provider and service value non-specific when purchased from a payment provider, retailer, distributor, or the like.

A prepaid payment card having features of the present disclosure comprises a unique identifier, prepaid transaction data associated with the unique identifier, and a reloading contact address readable by a user. The unique identifier and prepaid transaction data are generated and stored by a payment provider. The prepaid transaction data comprises prepaid service value information indicating the presence or absence of a designated service value associated with the unique identifier and service provider information indicating the presence or absence of a restriction on the use of the prepaid payment card to reloading a prepay account administered by an identified service provider. The reloading contact address directs users into communication with either a payment provider reloading interface system or a service provider reloading interface system, and is used to either allow the end user to contact the payment provider to reload a prepay account with the card, or to allow the service provider to contact the payment provider to confirm and complete the transaction.

The generic card is created when a payment provider generates and stores unique identifiers and associated prepaid transaction payment information so that generic cards, capable of being associated with identified service providers or designated prepaid service values at any time between their generation and point of sale, may be sold. The generic cards comprise prepaid service value information that indicates the absence of a designated service value, and the service provider information indicates the absence of a restriction on the use of the prepaid payment card to reloading a prepay account administered by an identified service provider. Using this method, a purchaser can thus determine the service value to be purchased at the point of sale, defer service provider choice until activation, and still retain a physical version of the prepaid payment card.

Prepaid payment cards may be imprinted on electronically readable cards, electronically stored and transmitted to purchasers, or printed on receipts at the point of sale by a point of sale activation device. In cases in which payment providers purchase service provider unique identifiers, the present invention can be used to purchase and resell prepaid service value used to reload a prepay account. The payment provider generates a unique identifier with associated prepaid transaction data comprising prepaid service value information indicating the presence of a designated service value associated with the payment provider unique identifier, wherein the designated service value is equal to the service value information associated with the service provider unique identifier. The service provider information need not restrict the use of the prepaid card to an identified service provider. When many service provider unique identifiers are purchased associated with various service providers and service values, the prepaid payment card can be sold in service value amounts covering the service provider unique identifiers purchased, and can be used for a variety of service providers when reloading. The payment provider unique identifier and associated prepaid transaction data are stored in a payment provider database, and the payment provider sells the prepaid payment card to a purchaser. Prepaid service value and service provider information can be updated, e.g., in the payment provider database, to indicate a designated service value or identified service provider restriction at any point in the process to achieve desired outcomes as necessary.

The current disclosure meets a need in the art by allowing consumers to reap the benefits innate in a physical card while avoiding the disadvantages to retailers, payment providers, and service providers inherent in the physical card model. Retailers are able to avoid the disadvantageous maintenance of a large inventory that usually accompanies the sale of physical cards. Payment providers are likewise able to avoid the disadvantageous maintenance of a large inventory, as they will no longer be required to purchase service provider-generated unique identifiers for storage and subsequent sale to consumers or retailers. The service providers are benefited by the fact that they will no longer have outstanding liabilities for unsold service provider-generated unique identifiers remaining in a distribution stream.

### BRIEF DESCRIPTION OF THE DRAWINGS

For a fuller understanding of the nature and advantages of the present disclosure, reference should be had to the following detailed description taken in connection with the accompanying drawings, in which:

FIG. 1 shows an embodiment of the system and method for purchasing and distributing prepaid network time;

FIG. 2 shows a system for implementing a reloading transaction wherein the end user contacts a payment provider to reload a prepay device;

FIG. 3 shows an alternative system for implementing a reloading transaction wherein the end user contacts a service provider to reload a prepay device, or to access a prepay service;

FIG. 4 shows a best mode interactive voice response system menu for use in a reload transaction.

### DETAILED DESCRIPTION

Disclosed herein is a new system and method for purchasing and distributing prepaid network time from a service provider using a prepaid payment card. The invention described encompasses a prepaid payment card, and systems and methods for using and making such cards.

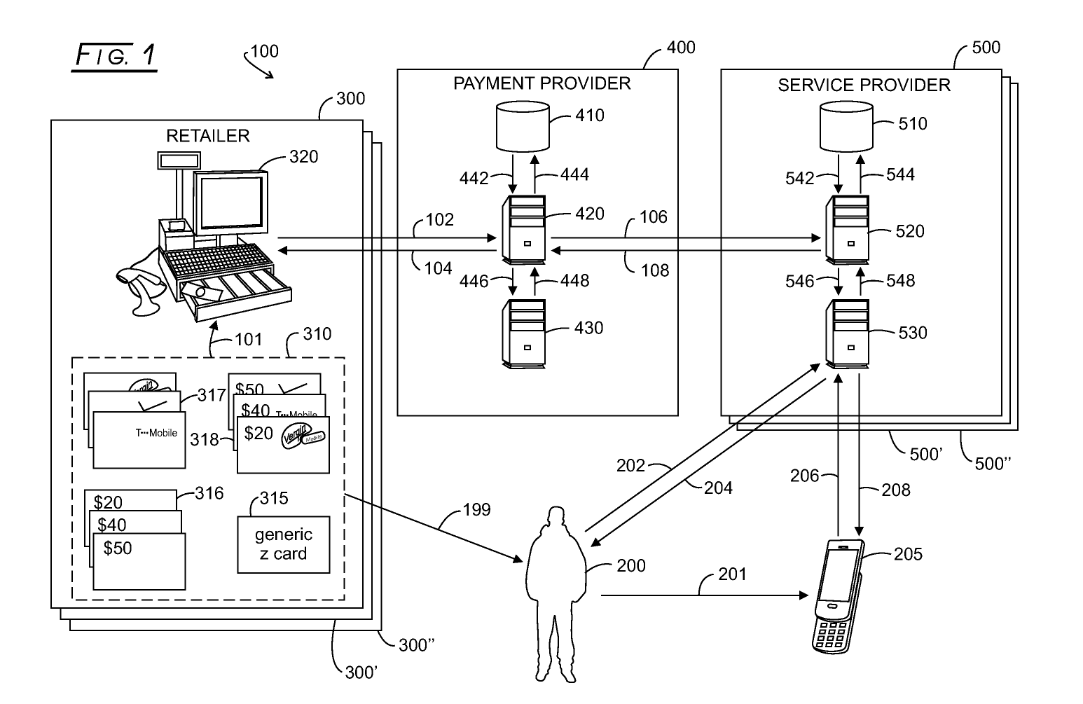

FIG. 1 depicts components and elements that will be common in uses and implementations of the current invention, and generally shows a prepaid service system 100. For purposes of clarity, the present disclosure will discuss the invention with relation to a prepaid system 100 shown particularly for use with prepaid cellular phone service. Those skilled in the art will appreciate that this system and method may be used in other embodiments in which consumers have the need to purchase prepaid network time or other types of prepaid services from service providers.

In a typical scenario, end users of prepay cellular telephone service choose a service provider with which to maintain a prepay account. Prepaid system 100 depicts an end user 200 who owns or is associated with a prepaid service access device 205, via arrow 201. A prepaid service access device can be an apparatus, for example, such as a cellular phone as shown as 205 in FIG. 1, a data-capable smart phone, a tablet computer, or other comparable communications device that requires network access. In other scenarios, the device might be an infrared or microwave toll road access device, a voice band or cable modem, or any other such device that may utilize meterable prepaid services in the performance of its intended function. An access device might also be, for example, software operated on a personal computer that utilizes a prepay account to provide a service to the end user, such as music library software.

Prepaid service access devices are usually associated with a particular service provider, for example, chosen from among multiple service providers (e.g., those shown as 500, 500′, 500″ in FIG. 1) or as an exclusive provider of service for the particular brand of access device. For the purposes of this disclosure, service providers are defined as persons or entities that provide end users with access to resources on a prepay basis. In FIG. 1, wherein a prepaid cellular device 205 is shown as an example, the end user 200 has chosen service provider 500 to provide his prepay cellular device 205 with access to the global communications network. Generally, a service provider 500 will recognize an access device during its attempt to use network resources (such as when the prepaid cellular device 205 is used to place a call), and will utilize a processing CPU 520 to query its prepay customer accounts in database 510, via 542 and 544, to determine whether to provide the access device with the network resources being requested. Service providers generally use prepay customer accounts to track customer access to prepaid resources by, for instance, maintaining access data and available prepaid service balances. Access data is defined as any set of data used to match a prepaid service access device to a prepay account, or used to permit a prepay customer to access his or her prepay customer account.

The customer interface 530 is a system that enables a prepay customer to communicate with the service provider regarding his or her prepay account. As will be described in further detail below, a reloading contact address of the customer interface system 530 will provide end users with a means for communicating with the customer interface system 530 (e.g., a telephone number or web address). Communication between the customer and the service provider can be accomplished directly through the access device, for example, as shown via arrows 206 and 208. Alternatively, the communication between the end user and the service provider can occur indirectly through some other communication means. For example, as shown via arrows 202 and 204, the end user 200 can communicate with the service provider 500 through an interactive voice response (IVR) system, web interface, or other comparable means, at 530.

The preceding description of service provider systems is not meant to be limiting, but merely illustrates the general functions performed by a service provider, a service provider's agent, or some combination thereof. The processing CPU 520 generally represents any data processing and computer architecture that is capable of performing queries, processing network time transactions, and other such maintenance, relaying, communicating, and processing operations as needed. It will facilitate communication with and between payment provider systems (e.g., 420, via 106, 108), customer records databases (e.g., 510, via 542, 544), and customer communications interfaces (e.g., 530, via 546, 548). The service provider database 510 functions to record prepay customer access data used to identify access devices (e.g., 205) and to track prepay accounts. It will be clear to those skilled in the art that any of these components can be physically or conceptually separated or combined to fit the needs of a particular business model, and are described separately from a functionality standpoint to facilitate ease of understanding.

For example, the CPU 520 may constitute multiple processing servers connected via a Wide Area Network (WAN), and customer records may be stored in a database 510 that resides on a separate database server, on the multiple processing servers themselves, or with a third party agent under contract with the service provider to maintain customer records. An IVR system 530 may be employed by a third party in communication with CPU 520, implemented on a separate computing system in communication with CPU 520, or integrated as part of CPU 520, for instance. The analogous payment provider systems (i.e., 410, 420, 430) exemplify the same basic functionality as just described with respect to the service provider systems (i.e., data storage, internal and intersystem communication and processing, and external customer communication, respectively), but serve a different purpose, as will be further described in detail herein.

The end user 200 will utilize the current invention to “replenish” or “reload” his prepay account with the service provider 500. Many choices are available to the end user 200 regarding service provider choice—such as at 500′ and 500″—directly driving the demand for versatile methods for reloading prepay phones. Prepay consumers have a much higher likelihood to change service providers than post-pay consumers, as the latter are often contractually obligated to receive service from the service provider for extended periods of time. The no-contract nature of prepay services, on the other hand, allows consumers to readily change providers to take advantage of special offers and cheaper prices.

Retailers of prepaid phone cards are numerous, and are represented generally at 300. These retailers are generally convenience stores, large box retail stores, gas stations, etc., and provide consumers with many locations at which they may purchase or activate phone cards or reload prepaid phones, such as at 300′ and 300″. For the purposes of this disclosure, retailer 300 will be considered to be a general retailer offering a selection of prepaid phone cards 310 and a POSA system 320, although no particular characteristics are necessary.

The retail transaction processing component of the POSA system 320 can be a simple mechanical cash register in its most basic form, or may also have the ability to electronically process retail transactions. The POSA system 320 may also include a component for communication with payment provider funding and activation CPUs, such as the payment provider funding and activation CPU 420. Advanced POSA systems 320 may incorporate Internet connectivity into the retail transaction processing component, or may include a device separate from the cash register to communicate with funding and activation CPUs. For example, the cash register may be equipped to visit funding and activation websites through standard browser software, or the payment provider may provide a purpose-specific computing device usable by the consumer. A simple POSA system might utilize a telephone to call a payment provider and activate phone cards at the point of sale. Those skilled in the art will understand the various combinations of prior art communication and transaction processing components that may be used in the present invention.

The retailer 300 also stocks prepaid phone cards 310 in its inventory. The current invention allows the retailer 300 to sell four main types of physical phone cards: fixed value provider cards 318 that have a designated prepaid service value and service provider; provider cards 317 that are restricted only to use with a designated service provider; fixed value cards 316 that are restricted only to use with a designated prepaid service value; and generic cards 315 that have no restrictions as to service provider or prepaid service value. Service value can be measured in terms of the consideration being provided by the consumer in exchange for services (e.g., U.S. dollars), or in terms of some measurement of the service provided based on industry metrics (e.g., network time). The aforementioned card types may be offered in any combination of quantities that is desirable or optimal given the needs of regional consumers, and in combination with other types of prepaid products that are known in the prior art. For example, the cards described in this disclosure may be offered for sale along with RTR products, including paper receipts or electronic confirmations.

The method begins with a payment provider CPU 420 generating a plurality of unique identifiers and storing that data in a payment provider database 410, via 442. Each unique electronic identifier represents an individual prepaid transaction record (i.e., a prepaid payment card), and is associated with prepaid transaction data, which at a minimum includes prepaid service value information and service provider information. Prepaid transaction data may additionally include batch numbers, serial numbers, or other such data so as to generate four main types of prepaid transaction records: records that are restricted only to use with a designated service provider (e.g., mobile carrier) or a combination of designated service providers; records that are restricted only to use with a designated prepaid service value; records that are a combination of both; and open records that carry no such restrictions as to carrier and prepaid service value. These records directly correspond to card types 317, 316, 318, and 315, respectively.

The particular database structure utilized to practice this aspect of the invention—the association of prepaid transaction data with the unique identifiers—will vary based on commercial considerations known to those skilled in the arts. As such, no particular structure need be seen as limiting for the purposes of the present disclosure. For example, a unique identifier can be associated with prepaid transaction data such as service provider information by way of a one-to-many association in a relational database, with one or more designated service provider records being associated with a particular unique identifier at the time the unique identifier is generated. In that case, the unique identifier in question would be restricted to use with the one or more designated service providers at the time of its creation. Alternatively, a unique identifier can also be associated with prepaid transaction data such as service provider information by the absence of any such designated service providers, whether that absence is manifested by null records, placeholders, future record creation, existing but unpopulated database architecture, or the like. Therefore, prepaid transaction data are “associated” with unique identifiers—whether present or absent—when the particular database structure chosen by one practicing the invention allows the payment provider to determine whether or not value and service provider designations are present, and their values, if any.

The data are then distributed to retailers, such as those at 300, 300′, and 300″. This can be carried out in several ways, with the preferred embodiment being physical distribution accomplished by preprinting unique identifiers on physical objects, e.g. plastic credit cards 310. It might also be implemented by electronic distribution utilizing POSA machines 320 located at the retail store 300, electronic distribution utilizing the internet, or the like. Therefore, as used herein, prepaid payment card generally refers to any vehicle or process that has the ability to communicate a unique identifier to an end user, including but not limited to, physical cards or tokens, related packaging, embedded software, or electronic messages. The best mode of the present invention, however, is considered to be the employment of physical cards, as at 310, to convey the unique identifiers, in order to best achieve the desirable characteristics stated above.

In one embodiment shown in FIG. 1, an end user 200 desires to make a payment to a prepay cellular phone account with his service provider 500. The end user 200 may or may not be the initial purchaser of a prepaid payment card 310 from the retailer 300. The current invention allows the initial purchaser at the retail store 300 to purchase a generic card 315, which is then funded by the retailer's 300 POSA system 320. The funding process can serve two purposes: to fund a dead (i.e., inactive) card as provided for in the prior art, or to designate a service value with the card's 315 unique identifier. Allowing a service value to be designated with the unique identifier at the point of sale permits payment providers 400 to sell prepay cards 315 and 317, for example, without a predetermined restriction on the price of the card or corresponding value of the prepay services.

To fund a card, the retail store's 300 POSA system 320 communicates with the payment provider's funding and activation CPU 420 via arrows 102 and 104. The funding and activation CPU 420 comprises a host computer capable of accessing a payment provider database 410 and communicating with other host computers (e.g., service provider CPU 520) and POSA systems 320. CPU 420 may, for instance, be a mainframe computer, a server or server farm, a personal computer, or the like. CPU 420 communicates with database 410, via arrows 442 and 444, to retrieve and update the prepaid transaction record associated with the particular unique identifier carried on a prepay card 310 to, for example, label the prepaid transaction record activated, or to fund a card. The CPU 420 uses information received from the POSA system 320, via 102, to query and update the records in the payment provider database 410 via 442 and 444, and can communicate these changes back to the POSA system 320 via 104 for verification and display.

By way of example, an initial purchaser (not shown in FIG. 1) might purchase a card 310 as a gift to end user 200, as at 199. Unsure of the identity of the end user's 200 service provider 500, the initial purchaser would choose either the generic card 315 or the fixed value card 316. The initial purchaser would then fund or activate the card through the retailer's 300 POSA system 320 at 101, either by presenting the card for purchase at a checkout counter, or by utilizing a self-service machine.

If the initial purchaser chose to purchase the fixed value card 316, the POSA system 320 would activate the card as provided for in the prior art if offered for sale in a dead (i.e., inactive) state by transmitting a verification of purchase to the funding and activation CPU 420 via 102, wherein the corresponding record in database 410 would be updated via 442 as active. The activation of a dead card thus occurs when a designated prepaid service value associated with the unique identifier is flagged as available and authorized to be used to reload a prepay account. Otherwise, if the card 316 were to be sold in the active state, the initial purchaser would simply exchange the purchase price for the card 316. A specific service provider (or multiple specific service providers) could optionally be designated for the card 316 at the time of funding or purchase as well if so desired, although it would not be necessary. The initial purchaser could then gift the fixed value card 316 to the end user 200, as at 199, who could then reload his prepay cellular account regardless of the identity of his service provider.

On the other hand, if the initial purchaser chose to purchase the generic card 315, the funding step would be necessary. Both the generic card 315 and the provider card 317 are sold without a designated prepaid service value associated with the unique identifier carried by the card. An unfunded card is thus defined as a prepaid payment card carrying a unique identifier that is associated with prepaid service value information that indicates no designated service value prior to purchase, and by definition are sold in the inactive state as well.

For example, the card funding and activation process is shown in FIG. 1. After choosing the generic card 315 and presenting it for purchase at the POSA system 320 via arrow 101, the POSA system 320 establishes a communication link 102 (either directly or indirectly) with funding and activation CPU 420. The communication link can be established via a direct connection through the Internet between the POSA system 320 and the CPU 420, a web interface accessed through POSA system 320, a telephone voice connection, temporary storage for batch processing, or other similar communication methods known in the art.

The POSA system 320 sends a funding request to the CPU 420 via 102, which includes the generic card's 315 unique identifier and the desired prepaid service value that is to be designated. The CPU 420 then queries the database 410 via arrow 442 to determine whether the unique identifier exists. If the database 410 returns a positive match, via arrow 444, it is again queried via arrow 442 to determine whether the unique identifier has any service value or service provider designations already associated with the card 315. If designations are already present, the CPU 420 transmits an error message back to the POSA system 320 via the communication link, as at 104. If no errors are found, the CPU 420 updates the prepaid transaction data associated with the card's 315 unique identifier, said data being stored in the database 410. The updating process occurs via arrow 442 and associates the designated prepaid service value with the unique identifier, thereby creating a balance for the identified card 315 that is may be used to reload a prepay account. After determining that it has successfully updated the record associated with the card 315 via 444, the CPU 420 transmits a confirmation to the POSA system 320 via link 104, and the sale is completed.

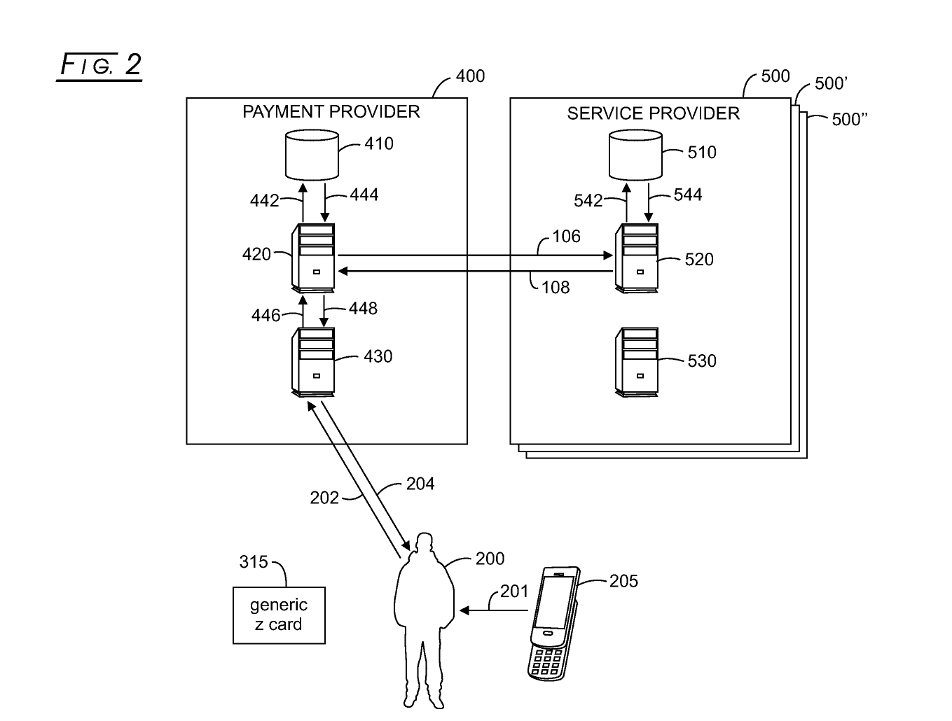

Turning to FIG. 2, the process for using a card is shown. Once a prepaid transaction record is funded and activated, the end user 200 can contact the payment provider's 400 reloading interface system 430 via arrow 202 to initiate reloading for the prepay account associated with the end user's 200 cellular phone 205. The reloading contact address is provided with the prepaid payment card to facilitate communication between the end user 200 and the interface system 430. A reloading contact address is any vehicle, method, or instrument that will direct the end user 200 to the appropriate interface system 430, and can be, for instance, a telephone number for an IVR system, a website address, the name of a smart phone application, or may even be a payment provider indicia or logo, so long as the logo is capable of directing the end user 200 to interface 430. The reloading interface system's 430 main function is to facilitate the exchange of information between end user wishing to reload (e.g., 200) and the payment provider 400. In the preferred embodiment, the reloading interface system 430 is embodied in a telephone-accessible interactive voice response system (IVR). Those skilled in the art will recognize that many interface possibilities exist, however. For instance, in one embodiment, the reloading interface system 430 can be any system capable of processing incoming end user communications, e.g. a web interface application that resides on a server.

Similarly, the reloading interface system 430, funding and activation CPU 420, and database 410 need not all reside in physically separate locations, but can be located together on the same server, mainframe, personal computer, or in other combinations. For example, the funding and activation CPU 420 and the reloading interface system 430 may reside on the same computer host, while the database 410 is housed in a separate facility. Computer and communication systems disclosed herein are functionally separated for purposes of clarity, but it is intended that they may be implemented in any number of prior art combinations to achieve the purposes contemplated by the current invention.

Card depletion (i.e., reloading) occurs when the designated service value associated with a card 315 (or some portion of it) is transferred into the prepay customer account with the end user's service provider 500. The end user 200 first relays information from card 315 as necessary, such as the card's 315 unique identifier, the end user's 200 service provider (e.g., carrier) choice 500, and the access data (e.g., phone number) of the account that the user 200 wishes to credit, via arrow 202 to the IVR 430. For example, IVR 430 could alternatively request the unique identifier and present a list of service providers from which the end user 200 makes a selection. If the prepay card being used by the end user 200 is a provider card, then only the unique identifier will be needed to identify the correct service provider 500.

The IVR 430 can also be configured to request the portion of the total designated prepaid service value with which the end user 200 wishes to reload phone 205. Some end users may desire a value less than the entire balance of the prepay card to be used for a particular reloading transaction. Alternatively, the IVR 430 can be configured to direct the reloading, via 446, of the end user's 200 prepay account with the entire balance of the card 315 without direction from the end user 200.

Other access data may be gathered as needed based upon various service provider requirements. Implementing the preferred use of the disclosed new system contemplates a payment processor 400 interfacing, through 106 and 108, with service provider prepay account systems, wherein the funding and activation CPU 420 communicates with the service provider processing CPU 520 during a reloading transaction. Because the preferred implementation entails an electronic data connection between these entities, the network and data architecture of the various service provider systems 520 will control the access data needed from end user 200. For example, service provider 500 may utilize the end user's 200 phone number as the sole method of accessing the prepay account associated with a service access device (e.g., phone 205). This architecture is in fact the predominant method currently used in the industry. However, it is possible that service provider 500′, for instance, may utilize a unique account number in lieu of an identifier such as a phone number. Alternatively, service provider 500″ may require a payment processor to provider an account number, phone number, and zip code before granting access to end user's 200 prepay account, or similar access data may become required by law. It is intended that the IVR system 430 be configured to gather any information needed to perform the steps of the invention.

After gathering the necessary information, the IVR 430 contacts the funding and activation CPU 420, transmitting information regarding the transaction via arrow 446. Information gathering can occur all at once, or several times throughout the described process as necessary to limit connection times. Using the information relayed from the IVR 430, the CPU 420 requests via arrow 442, and receives via arrow 444, information from the database 410 regarding the prepaid transaction record associated with the unique identifier entered by the end user 200. CPU 420 then interfaces with the service provider's processing CPU via arrow 106 to conduct a reloading transaction. Using the access data entered by the end user 200, CPU 420 requests access to the end user's prepay account stored in database 510 through processing CPU 520, via 542. The corresponding prepay account information is returned to CPU 420 via arrows 544 and 108.

Using the information gathered from the end user 200 that indicates the designated prepaid service value (or portion thereof) and the access data to be used for the reloading transaction, CPU 420 transfers value from the payment provider 400 to service provider 500. The CPU 420 then instructs the prepay account system 520 via 106 to credit the end user's 200 account in the database 510 via 542 with a service value, sometimes converting the type of service value (e.g., an amount of prepay minutes at the prevailing exchange rate). The transaction amount used when calculating the conversion may be the amount requested by the end user 200, less fees charged by the payment provider 400. Service providers may alternatively store balances of funds and convert them to minutes when the network is accessed, in which case no conversion need take place at the time of the reloading transaction. The prepay payment system 520 accesses prepay account information in account database 510 using the access data provided by the CPU 420, via arrow 106, and credits the prepaid service balance on the account. The transaction is then confirmed via connection 108, said confirmation being relayed to end user 200 through the IVR 430 and arrows 448 and 204. CPU 420 additionally updates database 410 via 442 by reducing the balance associated with the unique identifier for the card 315.

In a further embodiment, prepaid transaction data can be generated that are generic as to service providers, but contain a designated fixed value when generated. Referring back to FIG. 1, these fixed value cards 316 may be sold in an active state to retailers who do not have the technology to implement POSA 320 funding and activation techniques. Retailers 300 whose market segment may be largely skewed to a single service provider 500 may find that selling fixed value provider cards 318 is the lowest cost manner of providing a prepay product. Thus, various combinations and communication methods will allow the payment provider to mimic the current art while still allowing the payment provider to produce and market generic cards.

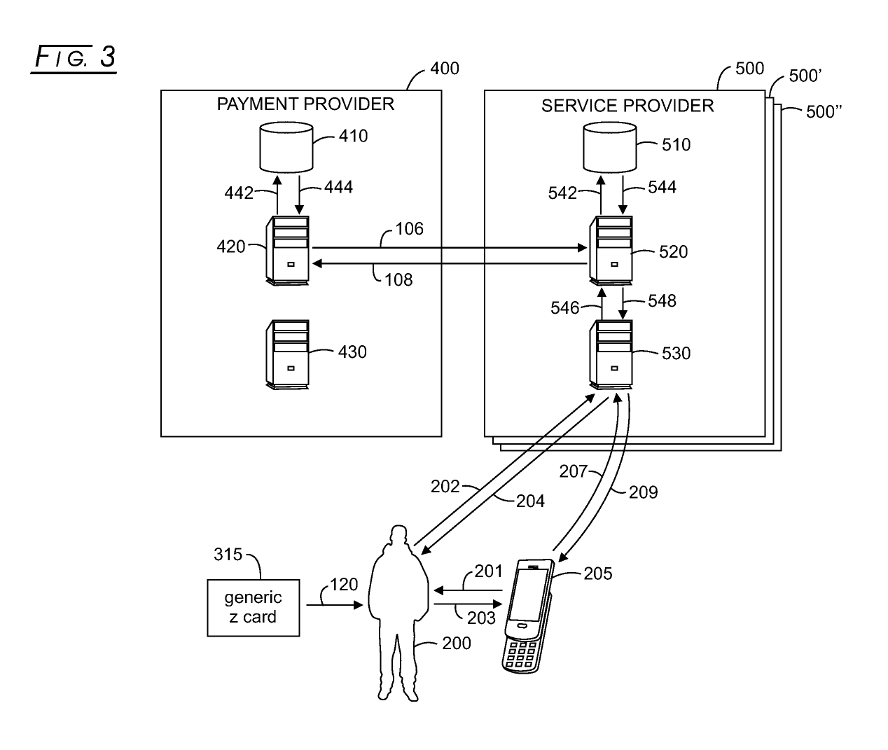

Turning to FIG. 3, an alternative method of reloading that may be implemented using the current invention is depicted. This embodiment involves the payment provider 400 agreeing to provide access to its database 410, thereby allowing the service provider 500 to communicate with end user 200 to approve and process reloading transactions. Using this configuration, indicia on the prepay card 315 would yield reloading contact address information to the end user 200 through 120 instructing the end user 200 to contact the service provider 500 when he or she wishes to reload the phone 205 using the designated prepaid service value associated with the card 315 (instead of the payment provider 400, as in FIG. 2).

The end user 200 would proceed by contacting the service provider reloading IVR 530 or other comparable communication interface using the reloading contact address, via 202, thereby initiating the reloading process. Service providers employing this configuration would then collect the information necessary to access the end user's 200 account (i.e., access data) through its IVR system 530 by prompting the end user 200 for the information through 204. The access data is then communicated to the processing CPU 520 via arrow 546, which then queries the database 510 via 542 regarding the existence and status of the user account. Assuming a valid, reloadable prepay account is found, the IVR 530 prompts the end user 200 for the unique identifier for the card 315 that they wish to use. Prompts to key in information identifying a particular payment provider may also be necessary to determine the appropriate provider to contact, if such information is not readily identifiable through the unique identifier. It can additionally prompt the end user 200 for a specific value that they wish to use via 204, if desired. The end user 200 conveys the unique identifier via arrow 202, and the unique identifier is then sent to the prepay payment system 520 via arrow 546.

It should be noted that while any interface system that will accomplish the objects of the current invention can be used to make the communications identified at 202 and 204, prepaid service access devices (such as the cellular device depicted at 205) can serve as the communications link. Information can be relayed directly to the service provider's 500 systems, for example, via 201 and 207, and receive information via 209 and 203. The steps involving prompting the end user 200 for access data could be eliminated from the process using this method, for example.

The processing CPU 520 next establishes a connection with the funding and activation CPU 420, and sends a depletion request via 108. The depletion request contains the unique identifier of the card 315, and the requested prepaid service value to be used, if entered by the end user 200. The CPU 420 then accesses database 410 via arrow 442 and determines the designated prepaid service value balance associated with the unique identifier. Depending on the protocol established between the payment provider 400 and the service provider 500, the CPU 420 may approve a reload transaction for the entire balance of the card 315, or for a lesser amount requested by the end user 200. This amount is then deducted from the balance in database 410 and transferred to the service provider 500 via connections 444 and 106, less payment provider fees. Alternatively, processing fees may be deducted from the balance at the moment the card 315 is initially funded at the retail store or at some other convenient time.

After receiving a value transfer from the payment provider 400, the processing CPU 520 exchanges the value for prepaid service time, if necessary, at the prevailing exchange rate. The converted minutes are then deposited into the end user's 200 prepay account in the database 510 via arrow 542. The prepay payment system 520 then confirms the transaction to the end user 200 via the IVR 530 and arrows 544, 548 and 204. If desired, the prepay payment system may also read the final minute or value balance of the account in the database 510 and transmit the information to the end user 200 in a similar manner.

The configuration depicted in FIG. 3 is especially well suited when used with prepay long-distance calling cards with a slight variation. Instead of depositing minutes into the prepay database 510, the processing CPU 520 can incrementally deplete the funds associated with the card 315 as the end user 200 utilizes the service provider's 500 network. This can be accomplished generally in two ways, depending on agreements between payment providers 400 and service providers 500. First, the prepay payment system 520 can transfer the entire balance associated with the card 315 via 106 to a temporary account held by the service provider 500, whereby the account is incrementally depleted as each minute of network access time passes. When the funds are exhausted or the end user 200 ceases its network use, the processing CPU 520 can indicate a zero balance to the CPU 420, or transfer the remaining funds back to the payment provider 400, respectively, via 108. Alternatively, the processing CPU 520 can maintain a persistent connection 106, 108 with CPU 420, instructing It to incrementally deplete the funds associated with the card 315 in the database 410 via 442 and 444, until the end user 200 ceases to use network access time, or the CPU 420 signals that the balance of the account in the database 410 has been exhausted.

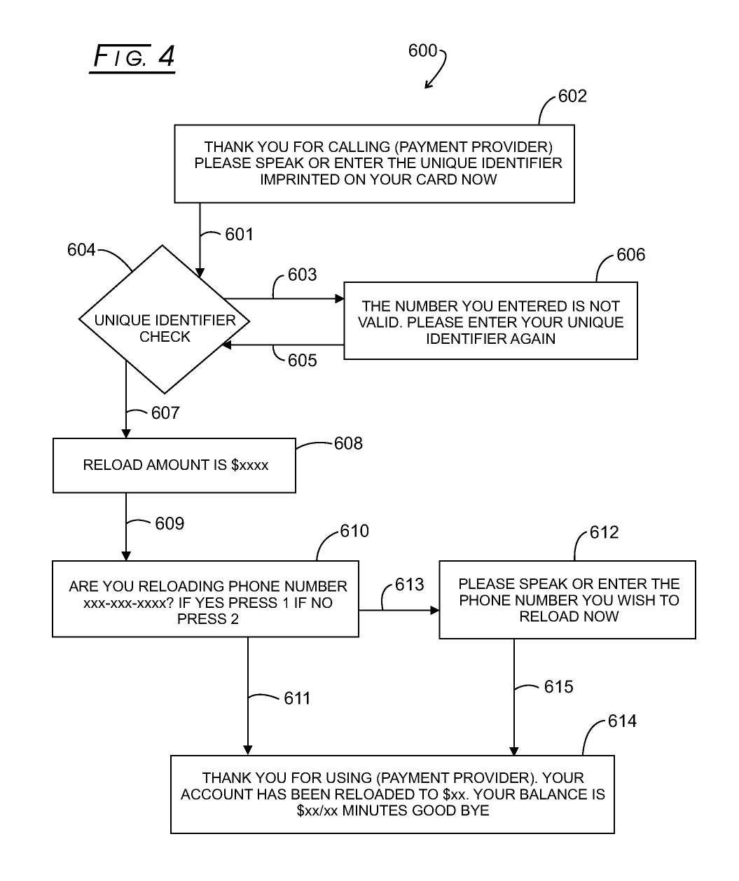

The IVR system described above is the preferred embodiment of the reloading transaction system 430 depicted in FIGS. 1-2. To further facilitate the implementation of the best mode of the current invention, FIG. 4 demonstrates the preferred IVR menu tree 600 that is presented to an end user of the system. The IVR system is first entered by an end user when they dial a toll free telephone number that can be imprinted onto a prepay card, or otherwise communicated to the end user. The end user is first presented with a welcome message, as at box 602, and is prompted to speak or enter the unique identifier associated with the prepay card. The system then checks the database of prepaid payment data to determine if the unique identifier is valid, at 604 via 601. If the unique identifier is invalid as at 603, the user is informed of the invalidity, and is prompted to enter the unique identifier again at 606. The checking process continues via 605 and is repeated until a valid unique identifier is entered, or the system disconnects after a predefined number of attempts are made.

A positive result from the query performed at 604 means that a valid unique identifier has been entered, and arrow 607 is followed to box 608, where the user is presented with the value that was associated with the unique identifier upon initial creation, or after the funding process as described and depicted in FIG. 1. It is preferred that the end user must reload a phone with the entire value associated the card, to prevent the increased chance of fraud if the card is lost or stolen.

Continuing via arrow 609 to box 610, the end user is asked whether they are calling from the phone that they wish to reload. If so, the end user is prompted to enter “1” and via arrow 611 the system accesses the service provider's prepay payment system by using the phone number to determine the appropriate service provider. As described in connection with FIG. 1, the IVR communicates with the service provider's processing CPU through its own funding CPU and uses the phone number to access the prepaid account information maintained by the service provider. It then converts the value to minutes, in the case of prepaid cellular services, and deposits them into the end user's prepay account. The system also determines the new minute or funds balance of the account and relays the information to the end user, as at box 614.

If the end user wishes to reload a phone other than the one on which the call is being, they are prompted to enter “2” and via arrow 613 they are taken to box 612, where an additional prompt to enter the phone number that they intend to reload is provided. After entering a valid phone number, the process described at via arrow 611 is repeated for the new phone number via arrow 615. The user is finally informed of the new minute or funds balance at box 614.

While the invention has been described with reference to preferred embodiments, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Since certain changes may be made in the above compositions and methods without departing from the scope of the invention herein involved, it is intended that all matter contained in the above descriptions and examples or shown in the accompanying drawings shall be interpreted as illustrative and not in a limiting sense. In this application all units are in the metric system and all amounts and percentages are by weight, unless otherwise expressly indicated. Also, all citations referred herein are expressly incorporated herein by reference. All terms not specifically defined herein are considered to be defined according to Webster's New Twentieth Century Dictionary Unabridged, Second Edition. The disclosures of all of the citations provided are being expressly incorporated herein by reference. The disclosed invention advances the state of the art and its many advantages include those described and claimed.

We claim:

1. A prepaid payment card for reloading a prepay account comprising:
(a) a unique identifier generated by a payment provider and stored by the payment provider in a payment provider database;
(b) prepaid transaction data associated with the unique identifier comprising:
(1) prepaid service value information indicating the presence or absence of a designated service value associated with the unique identifier; and
(2) service provider information indicating the presence or absence of a restriction on the use of the prepaid payment card to reloading a prepay account administered by an identified service provider; and
(c) a reloading contact address readable by a user, wherein the reloading contact address directs the user into communication with either:
(1) a payment provider reloading interface system; or
(2) a service provider reloading interface system.

2. The prepaid payment card as in claim 1, wherein:
(a) the prepaid service value information indicates the absence of a designated service value associated with the unique identifier until the prepaid payment card is funded;
(b) the service provider information indicates the absence of a restriction on the use of the prepaid payment card to reloading a prepay account administered by an identified service provider; and

3. The card as in claim 2, wherein the unique identifier is imprinted on a physical card.

4. The card as in claim 2, wherein the unique identifier is imprinted on an electronically readable card.

5. The card as in claim 2, wherein the unique identifier is electronically stored and transmitted to a purchaser.

6. The card as in claim 2, wherein the unique identifier is printed on a receipt at the point of sale by a point of sale activation device.

7. The prepaid payment card as in claim 1, wherein:
(a) the prepaid service value information indicates the absence of a designated service value associated with the unique identifier until the prepaid payment card is funded; and
(b) the service provider information indicates an identified service provider, thereby restricting the use of the prepaid payment card to reloading a prepay account administered by the identified service provider.

8. The prepaid payment card as in claim 1, wherein:
(a) the prepaid service value information indicates the presence of a designated service value associated with the unique identifier; and
(b) the service provider information indicates the absence of a restriction on the use of the prepaid payment card to reloading a prepay account administered by an identified service provider.

9. The prepaid payment card as in claim 1, wherein:
(a) the prepaid service value information indicates the presence of a designated service value associated with the unique identifier; and
(b) the service provider information indicates an identified service provider, thereby restricting the use of the prepaid payment card to reloading a prepay account administered by the identified service provider.

10. In a method for purchasing and reselling prepaid service value used to reload a prepay account administered by a service provider, of the type wherein a payment provider purchases a service provider unique identifier associated with a designated service value from the service provider, electronically stores the service provider unique identifier, and resells the designated value associated with the service provider unique identifier to a purchaser, the improvement comprising the steps of:
(a) the payment provider generating a payment provider unique identifier to be sold on a prepaid payment card;
(b) associating the payment provider unique identifier with prepaid transaction data comprising:
(1) prepaid service value information indicating the presence of a designated service value associated with the payment provider unique identifier that is equal in value to the designated service value associated with the service provider unique identifier; and
(2) service provider information indicating the absence of a restriction on the use of the prepaid payment card to reloading a prepay account administered by an identified service provider;
(c) storing the payment provider unique identifier and prepaid transaction data in a payment provider database; and
(d) selling the prepaid payment card carrying the payment provider unique identifier to the purchaser.

11. The method of claim 10, further comprising the step of updating the service provider information at the time the prepaid payment card is sold to indicate an identified service provider selected by the purchaser, thereby restricting the use of the prepaid payment card to reloading a prepay account administered by the identified service provider.

12. In a method for reloading a prepay account administered by a service provider, of the type wherein a payment provider sells a prepaid service value, and the prepaid service value is credited to the prepay account via an electronic interface between the payment provider and the service provider through which the prepaid service value is exchanged for a credit to the prepay account, the improvement comprising the steps of:
(a) the payment provider generating a payment provider unique identifier to be sold on a prepaid payment card;
(b) associating the payment provider unique identifier with prepaid transaction data comprising:
(1) prepaid service value information capable of indicating the presence or absence of a designated service value associated with the unique identifier, wherein the prepaid service value information indicates the absence of a designated service value associated with the unique identifier until the prepaid payment card is funded; and
(2) service provider information capable of indicating the presence or absence of a restriction on the use of the prepaid payment card to reloading a prepay account administered by an identified service provider, wherein the service provider information indicates the absence of a restriction on the use of the prepaid payment card to reloading a prepay account administered by an identified service provider;
(c) storing the payment provider unique identifier and prepaid transaction data in a payment provider database;
(d) selling the prepaid payment card carrying the payment provider unique identifier to a purchaser and funding the prepaid payment card by updating the prepaid service value information to indicate a designated service value associated with the unique identifier.

13. The method as in claim 12, further comprising the steps of:
(a) providing a reloading interface contactable by a user at a reloading contact address;
(b) receiving from the user access data associated with a user's prepay account;
(c) using the access data to access the user's prepay account;
(d) transferring consideration from the payment provider to the service provider;
(e) crediting the user's prepay account with a prepaid service value comparable to the consideration transferred to the service provider.

14. The method as in claim 13, wherein the steps are performed by the payment provider.

15. The method as in claim 13, wherein the steps are performed by the service provider.
